(19) United States
(12) Patent Application Publication
(10) Pub. No.: US 2022/0129499 A1
(43) Pub. Date: Apr. 28, 2022

(54) NETWORK SERVER AND METHOD FOR MANAGING PLAYLIST PROVIDED TO USER TERMINAL THROUGH NETWORK

(71) Applicants: NHN AD Corporation, Seongnam-si (KR); NHN Corporation, Seongnam-si (KR)

(72) Inventors: Jueun CHOI, Seongnam-si (KR); Yuna HYEON, Seongnam-si (KR)

(21) Appl. No.: 17/507,804

(22) Filed: Oct. 22, 2021

(30) Foreign Application Priority Data
Oct. 22, 2020 (KR) 10-2020-0137679

(51) Int. Cl. G06F 16/638; G06F 16/635; H04L 29/08

(52) U.S. Cl. CPC G06F 16/639; H04L 67/22; G06F 16/637

(57) ABSTRACT

A network server includes a communicator connected to a network; and at least one processor configured to communicate, through the communicator, with a user terminal connected to the network. The processor is configured to include or associate content IDs, determined according to one or more requests from the user terminal, in or with a playlist, the content IDs corresponding to content files, respectively, stored in a database; reflect actions of the user terminal, associated with one or more of the content files, on log data sets corresponding to the content IDs; and determine one or more of the content IDs as one or more target IDs to be selectively deleted or excluded from the playlist, on the basis of the log data sets.

### CROSS REFERENCE TO RELATED APPLICATION

This application claims priority from and benefits of Korean Patent Application No. 10-2020-0137679, filed on Oct. 22, 2020, which are hereby incorporated by reference for all purposes as if fully set forth herein.

### BACKGROUND

### 1. Technical Field

The present disclosure generally relates to a network system, and more particularly, to a network server and method for managing a playlist provided to a user terminal through a network.

### 2. Related Art

As the Internet is widely used, people prefer to download and play content such as music (or sound source) in real time in a streaming fashion rather than to store the content in a storage medium and then play the stored content. In such playback in the streaming fashion, in order to solve the inconvenience of having to search for content whenever a user plays the corresponding content, a playlist including desired content information may be provided to the user so that the user can play the content through the content information, thereby improving the user's convenience. However, if the content information is repeatedly included in the playlist, the playlist includes a relatively large amount of content information. In this case, the playlist may continue to accumulate content information which is not desired any more by the user, and accordingly, the user may feel inconvenient in playing content through the playlist.

The information described above is only provided for a better understanding of the background art of the technical features of the disclosure, and therefore it can not be understood as information which corresponds to the prior art known to those skilled in the art.

### SUMMARY

Various embodiments are directed to a network server and method capable of selectively deleting, adaptively to a user, content in a playlist.

In an embodiment, a network server may include: a communicator connected to a network; and at least one processor configured to communicate, through the communicator, with a user terminal connected to the network, wherein the at least one processor is configured to include or associate content IDs, determined according to one or more requests from the user terminal, in or with a playlist, the content IDs corresponding to content files, respectively, stored in a database; reflect actions of the user terminal, associated with at least a part of the content files, on log data sets corresponding to the content IDs; and determine at least a part of the content IDs as target IDs to be selectively deleted or excluded from the playlist, on the basis of the log data sets.

The at least one processor may be configured to transmit information, associated with the target IDs, to the user terminal; and delete or exclude, when a signal selecting at least a part of the target IDs is received from the user terminal, the at least a part of the target IDs from the playlist.

Each of the log data sets may include log data associated with playback of a corresponding content file in the user terminal during a predetermined time from a time point at which a corresponding content ID is included in or associated with the playlist.

The log data may include information associated with an operation of skipping at least a part of a progress time of the corresponding content file.

The log data may include data indicating times during each of which at least a part of the corresponding content file is played.

The log data may include data counting the number of times at least a part of the corresponding content file is played in the user terminal.

The at least one processor may be configured to determine scores corresponding to the content IDs, respectively, on the basis of the log data sets, and determine the target IDs according to the determined scores.

The content files may include music files to be received and played in real time by the user terminal.

In an embodiment, a method for managing a playlist provided to a user terminal through a network may include: including or associating content IDs, determined according to one or more requests from the user terminal, in or with the playlist, the content IDs corresponding to content files, respectively, stored in a database; reflecting actions of the user terminal, associated with at least a part of the content files, on log data sets corresponding to the content IDs; determining at least a part of the content IDs as target IDs, on the basis of the log data sets; and selectively deleting or excluding the target IDs from the playlist.

The deleting may include: transmitting information, associated with the target IDs, to the user terminal; and deleting or excluding, when a signal selecting at least a part of the target IDs is received from the user terminal, the at least a part of the target IDs from the playlist.

Each of the log data sets may include log data associated with playback of a corresponding content file in the user terminal during a predetermined time from a time point at which a corresponding content ID is included in or associated with the playlist.

The determining of the at least a part of the content IDs as the target IDs may include: determining scores corresponding to the content IDs, respectively, on the basis of the log data sets; and determining the target IDs according to the determined scores.

The determining of the scores may include: determining whether the log data includes information associated with an operation of skipping at least a part of a progress time of the corresponding content file; and determining a score of the corresponding content ID according to a determination result.

The determining of the scores may include: determining, from the log data, whether the number of times at least a part of the corresponding content file is played in the user terminal decreases with the lapse of time; and determining a score of the corresponding content ID according to a determination result.

The determining of the scores may include: determining, from the log data, whether the number of times at least a part of the corresponding content file is played in the user terminal is equal to or less than a threshold; and determining a score of the corresponding content ID according to a determination result.

The content files may include music files to be received and played in real time by the user terminal.

Some embodiments of the present disclosure provide a network server and method capable of selectively deleting, adaptively to a user, content in a playlist are provided. For example, the network server may determine target IDs among content IDs of the playlist by monitoring actions of a user terminal, and may selectively delete or exclude the target IDs from the playlist.

### BRIEF DESCRIPTION OF THE DRAWINGS

FIG. 1 is a block diagram illustrating a network system in accordance with an embodiment of the present disclosure.

FIG. 2 is a diagram illustrating information on a playlist displayed on a user terminal of FIG. 1.

FIG. 3 is a block diagram illustrating an embodiment of a content providing server of FIG. 1.

FIG. 4 is a diagram conceptually illustrating a playlist and content files of FIG. 3.

FIG. 5 is a diagram conceptually illustrating log data of FIG. 3.

FIG. 6 is a block diagram illustrating an embodiment of a playlist manager of FIG. 3.

FIG. 7 is a conceptual diagram illustrating non-preference scores determined by a non-preference score calculation unit of FIG. 6.

FIG. 8 is a flowchart illustrating a method for managing a playlist in accordance with an embodiment of the present disclosure.

FIG. 9 is a flowchart illustrating an embodiment of step S140 of FIG. 8.

FIG. 10 is a flowchart illustrating an embodiment of step S130 of FIG. 8.

FIG. 11 is a flowchart illustrating an embodiment of step S310 of FIG. 10.

FIG. 12 is a flowchart illustrating another embodiment of step S310 of FIG. 10.

FIG. 13 is a flowchart illustrating still another embodiment of step S310 of FIG. 10.

FIG. 14 is a block diagram illustrating an embodiment of a network server suitable for implementing a content providing server of FIG. 3.

### DETAILED DESCRIPTION

Hereinafter, embodiments of the disclosure will be described in detail with reference to the accompanying drawings. Hereafter, only parts necessary to understand the operation of the disclosure will be described, and it is to be noted that descriptions for the other parts will be omitted in order not to obscure the characterizing features of the disclosure. The disclosure may be embodied in different forms and should not be construed as being limited to the embodiment set forth herein. Rather, the embodiment is provided to describe the disclosure in detail to the extent that a person skilled in the art to which the disclosure pertains can easily carry out the technical ideas of the disclosure.

Throughout the specification, when one element is referred to as being ‘connected to’ or ‘coupled to’ another element, it may indicate that the former element is directly connected or coupled to the latter element or indirectly connected or coupled to the latter element with another element interposed therebetween. The terminology used herein is for the purpose of describing particular embodiments and is not intended to be limiting. In the entire specification, when an element “includes” a component, it means that the element does not exclude another component but may further include another component, unless referred to the contrary. “At least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

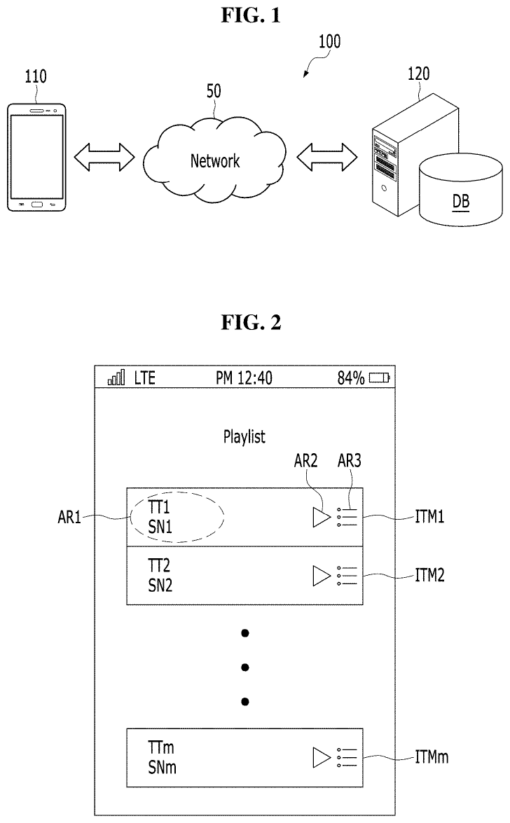

FIG. 1 is a block diagram illustrating a network system in accordance with an embodiment of the present disclosure.

Referring to FIG. 1, a network system 100 may include a network 50, a user terminal 110, and a content providing server 120.

The network system 100 may include a plurality of devices, servers and/or software components, which operate to perform various methods in accordance with some embodiments of the present disclosure described herein. The devices and/or servers illustrated in FIG. 1 may be configured in various or different ways. Operations and services provided by the devices and/or servers may be combined or separated for the embodiments described herein, and may be performed by a larger or smaller number of devices and/or servers. One or more devices and/or servers may be driven and/or maintained by the same company or different companies.

The network 50 connects components or devices in the network system 100, such as the user terminal 110 and the content providing server 120. The network 50 may include at least one among a public network such as the Internet, at least one private network, a wired network, a wireless network, other appropriate types of networks and combinations thereof. Each of the components in the network system 100 may perform at least one of a wired communication function and a wireless communication function. Thus, the components in the network system 100 may communicate with each other through the network 50.

The user terminal 110 may communicate with the content providing server 120 through the network 50, and thereby, may perform operations for using a service provided by the content providing server 120. For example, the user terminal 110 may access a webpage of the content providing server 120, and may register a user account in the content providing server 120. Also, the user terminal 110 may search content registered in the content providing server 120, may include the searched content in a playlist corresponding to the user account, and may receive, from the content providing server 120, and play content files corresponding to the content included in the playlist, in a streaming fashion. For example, the user terminal 110 may include a playback module which is configured to receive and play content files in the streaming fashion. Such a playback module may be implemented through hardware, software or a combination thereof.

In certain embodiments, the user terminal 110 may include a device capable of transmitting and receiving information in a wired and/or wireless environment, such as a computer, a UMPC (ultra mobile PC), a workstation, a net-book, a PDA (personal digital assistant), a portable computer, a web tablet, a wireless phone, a mobile phone, a smart phone, an e-book, a PMP (portable multimedia player) and a portable game machine.

The server for providing content or the content providing server 120 communicates with the user terminal 110 through the network 50. The content providing server 120 may provide information on the playlist to the user terminal 110, and, in response to a request from the user terminal 110, may provide the content files, corresponding to the content of the playlist, to the user terminal 110 from a database DB. The content files stored in the database DB may be music, audio or video files which are encoded to be suitable for being played in the user terminal 110 in the streaming fashion.

The content providing server 120 may collect logs representing actions associated with the playback of the content files by the user terminal 110, and may manage the playlist on the basis of the collected logs.

FIG. 2 is a diagram illustrating information on a playlist displayed on the user terminal of FIG. 1.

Referring to FIGS. 1 and 2, the user terminal 110 may receive a playlist screen from the content providing server 120 and display the playlist screen. The playlist screen may include a plurality of items ITM1 to ITMm. Each of the plurality of items ITM1 to ITMm may correspond to a content file to be provided by the content providing server 120. The user terminal 110 may request a content file corresponding to one of the plurality of items ITM1 to ITMm to the content providing server 120, and may receive, from the content providing server 120, and play the requested content file in the streaming fashion.

Each of the plurality of items ITM1 to ITMm may include a first area AR1 for displaying a part of metadata, for example, but not limited to, the name of a corresponding content, the creator of the content, and any information related to the content. For instance, FIG. 2 illustrates that a first item ITM1 includes a first music title TT1 and a first singer name SN1 in the first area AR1, a second item ITM2 includes a second music title TT2 and a second singer name SN2 in the first area AR1 and an m-th item ITMm includes an m-th music title TTm and an m-th singer name SNm in the first area AR1. Each of the plurality of items ITM1 to ITMm may further include a second area AR2 which includes an access link to a corresponding content file. In response to a user input selecting the second area AR2, the user terminal 110 may receive, from the content providing server 120, and play a content file corresponding to the user input or a corresponding item. Each of the plurality of items ITM1 to ITMm may further include a third area AR3 which includes an access link to the other part of the metadata of the corresponding content. In response to a user input selecting the third area AR3, the user terminal 110 may receive, from the content providing server 120, and display the metadata of the corresponding content, for example, the resolution (or sound quality), genre and publication date of the content.

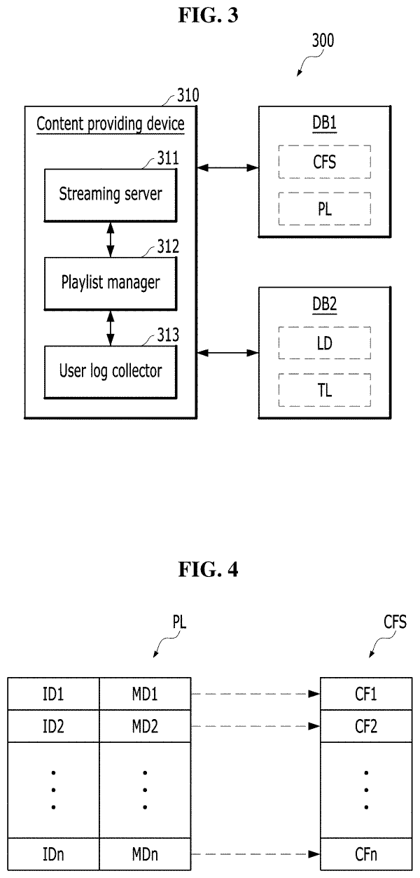

FIG. 3 is a block diagram illustrating an embodiment of the content providing server of FIG. 1. FIG. 4 is a diagram conceptually illustrating a playlist and content files of FIG. 3. FIG. 5 is a diagram conceptually illustrating log data of FIG. 3.

Referring to FIG. 3, a content providing server 300 may include a content providing device 310 and first and second databases DB1 and DB2. The content providing device 310 may include a streaming server 311, a playlist manager 312, and a user log collector 313.

The streaming server 311 is configured to retrieve and provide content files CFS, stored in the first database DB1, to the user terminal 110 (see FIG. 1). The content files CFS may be music, audio or video files which are encoded to be suitable for being played in the user terminal 110 in the streaming fashion. In some embodiments, the streaming server 311 may retrieve, in response to a status that a command indicating specific content is received from the playlist manager 312, a corresponding content file from the first database DB1 and provide the corresponding content file to the user terminal 110. The command indicating specific content may include a content ID.

The playlist manager 312 transmits the command indicating specific content to the streaming server 311 according to a content ID in a playlist PL stored in the first database DB1, such that the streaming server 311 transmits or provides a corresponding content file to the user terminal 110. Also, the playlist manager 312 is configured to update a content ID in the playlist PL in response to a request from the user terminal 110.

Referring to FIG. 4 together with FIG. 3, the playlist PL may include first to n-th content IDs ID1 to IDn. The playlist PL corresponds to the user account associated with the user terminal 110 of FIG. 1, and a separate playlist may be provided for another user account. A content ID may include, for example, but not limited to, a character, a code, a symbol, etc. suitable for identifying content and/or a content file. The playlist manager 312 may provide a list of content to the user terminal 110, and in response to a request from the user terminal 110, may add a content ID of content, selected in the list of content, to the playlist PL. In this way, the playlist PL may include the plurality of content IDs ID1 to IDn.

In certain embodiments, the playlist PL may further include first to n-th metadata MD1 to MDn corresponding to the first to n-th content IDs ID1 to IDn, respectively. In other embodiments, the first to n-th metadata MD1 to MDn may be stored in the first database DB1 as a data set separated from the playlist PL, and the playlist PL may include mapping information mapping between the first to n-th content IDs ID1 to IDn and the first to n-th metadata MD1 to MDn. Each of the first to n-th metadata MD1 to MDn may include associated information of corresponding content, such as the name, creator, resolution, genre and publication date of the corresponding content. The playlist manager 312 may provide a playlist screen (see FIG. 2), listing at least a part of each of the first to n-th metadata MD1 to MDn, to the user terminal 110 in response to a request from the user terminal 110.

The content files CFS may include first to n-th content files CF1 to CFn which are mapped to the first to n-th content IDs ID1 to IDn. The first to n-th content files CF1 to CFn may be stored to be associated with the first to n-th content IDs ID1 to IDn, respectively. In FIG. 4, dotted arrow lines conceptually show mapping relationships between the first to n-th content IDs ID1 to IDn of the playlist PL and the first to n-th content files CF1 to CFn. In certain embodiments, the first to n-th content files CF1 to CFn may also include the first to n-th content IDs (ID1 to IDn), respectively.

The user log collector 313 is configured to store, in the second database DB2, log data LD which represents and/or reflects actions of the user terminal 110 associated with at least a part of the first to n-th content files CF1 to CFn. Referring to FIG. 5 together with FIG. 3, the log data LD includes first to n-th log data sets LDS1 to LDSn corresponding to the first to n-th content IDs (ID1 to IDn), respectively. The user log collector 313 may record actions of the user terminal 110, associated with the playback of a content file, in a corresponding log data set. Further, time data AT indicating a time (e.g., a date) at which a content ID is added to the playlist PL according to or in response to a request of the user terminal 110 may be included in the log data set.

The log data set may include logs in the user terminal 110, associated with the playback of a content file. In embodiments, the user log collector 313 may be provided, from the user terminal 110, with information on a user input received by the user terminal 110, while a content file is being played in the user terminal 110, and may record the information in a user input log UIL of a corresponding log data set. For example, a user of the user terminal 110 may skip the playback of at least a part of a content file being played, by controlling or manipulating a user interface such as a progress bar or selecting a user interface for moving to the next content. The user log collector 313 may record information, associated with such an operation of skipping at least a part of a progress time of the content file, in the user input log UIL of the corresponding log data set. For example, the user input log UIL may include information on progress times skipped by one or more user inputs. For example, the user input log UIL may include information indicating the number of times that the progress time is skipped. In certain embodiments, the user log collector 313 may include or have data indicating times during each of which at least a part of the content file is played, in a playback history PBH of the corresponding log data set. For example, the playback history PBH may include time stamps which indicate times during each of which at least a part of the corresponding content file is played. For example, the playback history PBH may include information indicating the number of times that at least a part of the corresponding content file is played.

The playlist manager 312 may determine at least a part of the first to n-th content IDs (ID1 to IDn) as target IDs on the basis of the log data LD. The playlist manager 312 may determine non-preference scores corresponding to the first to n-th content IDs (ID1 to IDn), respectively, on the basis of the log data LD, and may determine at least a part of the first to n-th content IDs (ID1 to IDn) as target IDs according to the determined non-preference scores. The playlist manager 312 may store the determined target IDs as a target list TL in the second database DB2.

The playlist manager 312 may selectively delete or exclude the determined target IDs from the playlist PL. In some embodiments, the playlist manager 312 may transmit information, associated with the target IDs, to the user terminal 110. In the same manner as in the playlist screen (see FIG. 2), information associated with a target ID may include metadata, for example, the name and creator of content. For example, the user terminal 110 may display, together with the information associated with the target IDs, a message such as “Music that you are not interested in seems to be in the playlist. Do you want to delete the music from the playlist?.” The user terminal 110 may receive a user input of selecting at least a part of the target IDs, and may notify the selected target IDs to the playlist manager 312. The playlist manager 312 may delete or exclude the selected target IDs from the playlist PL.

In this way, the content providing device 310 may determine target IDs by monitoring actions of the user terminal 110, and selectively delete or exclude the target IDs from the playlist PL. Accordingly, the content providing device 310 may help the user to delete uninterested content from the playlist PL. Therefore, the content providing device 310 capable of deleting, adaptively to the user, content in the playlist PL is provided.

While FIG. 3 illustrates that the first and second databases DB1 and DB2 are included in the content providing server 300, this is a mere example, and the first and second databases DB1 and DB2 may be provided outside the content providing server 300. In this exemplary embodiment, the content providing device 310 may access the first and second databases DB1 and DB2 through the network 50 (see FIG. 1). Although the first and second databases DB1 and DB2 are illustrated as separate databases or components in FIG. 3, this is a mere example, and the first and second databases DB1 and DB2 may be integrated into one database. Alternatively, the first and second databases DB1 and DB2 may be implemented as three or more databases.

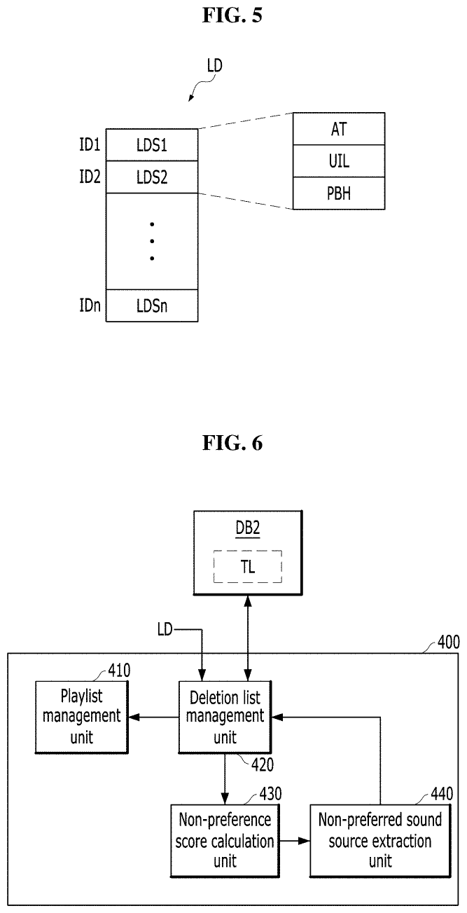

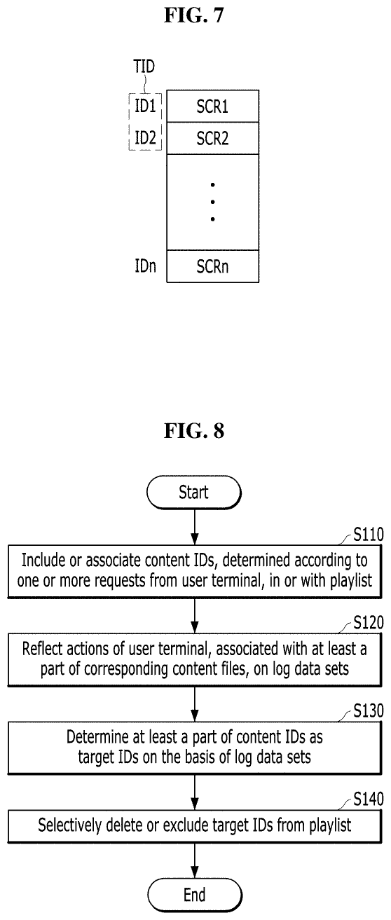

FIG. 6 is a block diagram illustrating an embodiment of the playlist manager of FIG. 3. FIG. 7 is a conceptual diagram illustrating non-preference scores determined by a non-preference score calculation unit of FIG. 6.

Referring to FIG. 6, a playlist manager 400 may include a playlist management unit 410, a deletion list management unit 420, a non-preference score calculation unit 430, and a non-preferred sound source extraction unit 440.

The playlist management unit 410 is configured to manage the playlist PL (see FIG. 3). The playlist management unit 410 may control the streaming server 311 (see FIG. 3) by transmitting a command to the streaming server 311 such that the streaming server 311 can provide a content file to the user terminal 110. The playlist management unit 410 may delete or exclude a content ID, determined as a target ID by the deletion list management unit 420, from the playlist PL.

The deletion list management unit 420 controls the non-preference score calculation unit 430 according to the log data LD (see FIG. 3) such that the non-preference score calculation unit 430 determines a non-preference score corresponding to a content ID. The deletion list management unit 420 may control, when a predetermined time elapses from a time point at which a content ID is included in or associated with the playlist PL, the non-preference score calculation unit 430 such that the non-preference score calculation unit 430 determines a non-preference score corresponding to the content ID. In some embodiments, the deletion list management unit 420 may determine whether the predetermined time has elapsed from the time point at which the content ID is included in or associated with the playlist PL, by referring to the time data AT (see FIG. 5) included in the first to n-th log data sets LDS1 to LDSn (see FIG. 5), respectively, of the log data LD.

The non-preference score calculation unit 430 may determine the non-preference score, corresponding to the content ID, on the basis of a corresponding log data set of the log data LD. In certain embodiments, when the user input log UIL (see FIG. 5) of the log data set includes information associated with a user input skipping at least a part of a progress time of a corresponding content file, the non-preference score calculation unit 430 may increase a non-preference score corresponding to the corresponding content ID. For example, the non-preference score calculation unit 430 may increase a non-preference score as the sum of skipped progress times increases. For example, the non-preference score calculation unit 430 may increase a non-preference score as the number of times a progress time is skipped increases. In some embodiments, when, on the basis of the playback history PBH (see FIG. 5) of the log data set, the number of times that at least a part of the corresponding content file is played is equal to or less than a threshold (e.g., 1), the non-preference score calculation unit 430 may increase a non-preference score. In certain embodiments, the non-preference score calculation unit 430 may increase a non-preference score as the number of times that at least a part of the corresponding content file is played is small. When, on the basis of the playback history PBH of the log data set, the number of times that at least a part of the corresponding content file is played decreases with the lapse of time, the non-preference score calculation unit 430 may increase a non-preference score. For example, when the numbers of times that the content file is played during time periods (e.g., dates) decrease with the lapse of time, that is, when the numbers of playback times during the time periods have a decreasing slope, the non-preference score calculation unit 430 may increase a non-preference score. First to n-th non-preference scores SCR1 to SCRn determined by the non-preference score calculation unit 430 are shown in FIG. 7. The first to n-th non-preference scores SCR1 to SCRn may correspond to the first to n-th content IDs (ID1 to IDn), respectively.

The non-preferred sound source extraction unit 440 is configured to determine target IDs according to the first to n-th non-preference scores SCR1 to SCRn. In some embodiments, the non-preferred sound source extraction unit 440 may determine a content ID having a non-preference score higher than a threshold, as a target ID. For example, the first and second non-preference scores SCR1 and SCR2 among the first to n-th non-preference scores SCR1 to SCRn may be lower than a predetermined threshold, and in this case, as illustrated in FIG. 7, the first and second content IDs ID1 and ID2 are determined as target IDs TID. The target IDs TID configure the target list TL.

The deletion list management unit 420 may determine, by referring to the log data LD, whether a content file corresponding to each of the target IDs TID is being played in the user terminal 110, and if the content file is being played in the user terminal 110, the deletion list management unit 420 may exclude a corresponding target ID from the target list TL. When a target ID is continuously included (or stored) in the target list TL for a specific time, the deletion list management unit 420 may notify the target ID to the playlist management unit 410. The playlist management unit 410 may delete the target ID from the playlist PL. In some embodiments, the playlist management unit 410 may transmit information associated with a target ID to the user terminal 110 (see FIG. 1), and may delete the target ID from the playlist PL in response to a feedback signal from the user terminal 110.

FIG. 8 is a flowchart illustrating a method for managing a playlist in accordance with an embodiment of the present disclosure.

Referring to FIG. 8 with reference to FIG. 1, the playlist PL (see FIG. 4) is configured at step S110. At step S110, the content providing server 120 includes or associates content IDs, determined according to one or more requests from the user terminal 110, in or with the playlist PL. For example, the user terminal 110 may request, in response to a user input, the content providing server 120 to include content in the playlist PL, and the content providing server 120 may include a corresponding content ID in the playlist PL. For example, when at least a part of a content file is provided to the user terminal 110, a corresponding content ID may be included in the playlist PL.

At step S120, the content providing server 120 monitors actions of the user terminal 110 associated with at least a part of the content IDs ID1 to IDn (see FIG. 4) included in the playlist PL, and thereby, reflects the actions of the user terminal 110 on the log data sets LDS1 to LDSn (see FIG. 5). The actions of the user terminal 110 may be associated with the playback of a content file. For example, the content providing server 120 may record information, associated with an operation of skipping at least a part of a progress time of a content file, in the user input log UIL (see FIG. 5) of a corresponding log data set. For example, the content providing server 120 may include data, indicating times during each of which at least a part of the content file is played, in the playback history PBH (see FIG. 5) of the corresponding log data set. For example, the content providing server 120 may count information, indicating the number of times that at least a part of the content file is played, in the playback history PBH of the corresponding log data set.

At step S130, the content providing server 120 determines at least a part of the content IDs ID1 to IDn as target IDs on the basis of the log data sets LDS1 to LDSn. When a predetermined time elapses from a time point at which a content ID is included in the playlist PL, whether the content ID is a target ID may be determined on the basis of a corresponding log data set. In this way, on the basis of the log data set which is updated until the predetermined time elapses from the time point at which the content ID is included in the playlist PL, a target ID may be determined.

At step S140, the content providing server 120 selectively deletes or excludes the determined target IDs from the playlist PL.

In this way, the playlist management method according to the exemplary embodiment of the present disclosure may determine target IDs by monitoring actions of the user terminal 110 associated with the content of the playlist PL and selectively delete or exclude the target IDs from the playlist PL. Accordingly, the playlist management method may help the user to delete uninterested content from the playlist PL and may increase the efficiency of the management of the playlist management method. Therefore, the playlist management method capable of deleting, adaptively to the user, content in the playlist PL is provided.

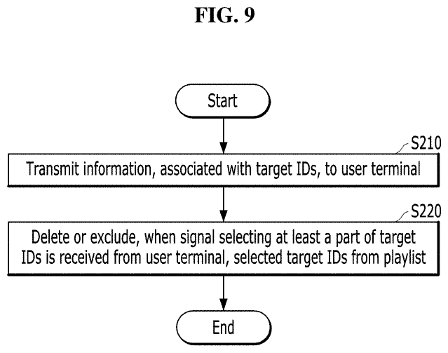

FIG. 9 is a flowchart illustrating an embodiment of step S140 of FIG. 8.

Referring to FIG. 9 with reference to FIG. 1, at step S210, the content providing server 120 transmits information, associated with the determined target IDs, to the user terminal 110. In the same manner as in the playlist screen (see FIG. 2) displayed on the user terminal 110, information associated with a target ID may include metadata, for example, the name and creator of content.

At step S220, when a signal selecting at least a part of the target IDs is received from the user terminal 110, the selected target IDs may be deleted or excluded from the playlist PL.

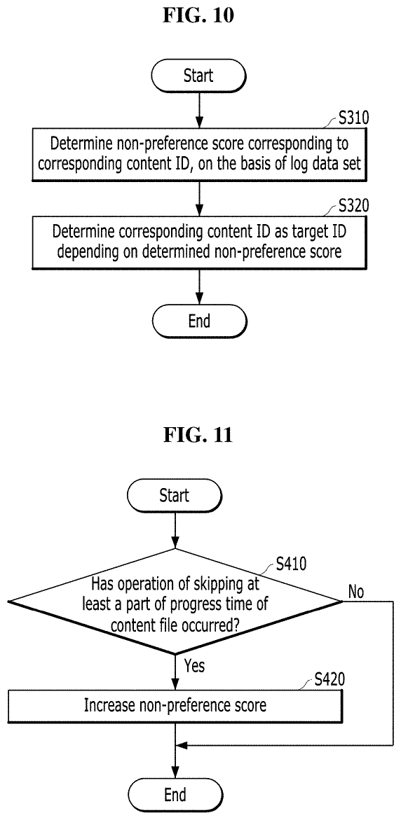

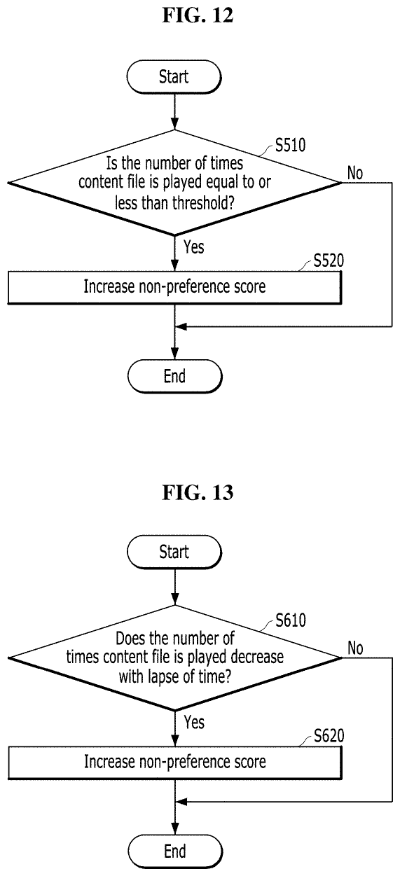

FIG. 10 is a flowchart illustrating an embodiment of step S130 of FIG. 8. FIG. 11 is a flowchart illustrating one exemplary embodiment of step S310 of FIG. 10. FIG. 12 is a flowchart illustrating another exemplary embodiment of step S310 of FIG. 10. FIG. 13 is a flowchart illustrating still another exemplary embodiment of step S310 of FIG. 10.

Referring to FIG. 10 with reference to FIG. 1, at step S310, the content providing server 120 determines a non-preference score, corresponding to a corresponding content ID, on the basis of a log data set.

In some embodiments, referring to FIG. 11, the content providing server 120 may determine, on the basis of the user input log UIL (see FIG. 5) of the log data set, whether an operation of skipping at least a part of a progress time of a content file has occurred (step S410), and may increase a non-preference score according to a determination result (step S420). For example, the user may skip at least a part of the progress time of the content file, and the content providing server 120 may increase a non-preference score as the sum of skipped progress times increases and/or the number of times the progress time is skipped increases.

In certain embodiments, referring to FIG. 12, the content providing server 120 may determine, on the basis of the playback history PBH (see FIG. 5) of the log data set, whether the number of times the content file is played is equal to or less than a threshold (step S510), and may increase a corresponding non-preference score according to a determination result (step S520).

In some embodiments, referring to FIG. 13, the content providing server 120 may determine, on the basis of the playback history PBH (see FIG. 5) of the log data set, whether the number of times that the content file is played decreases with the lapse of time (step S610), and may increase a corresponding non-preference score according to a determination result (step S620).

At step S320, the corresponding content ID is determined as a target ID depending on the determined non-preference score.

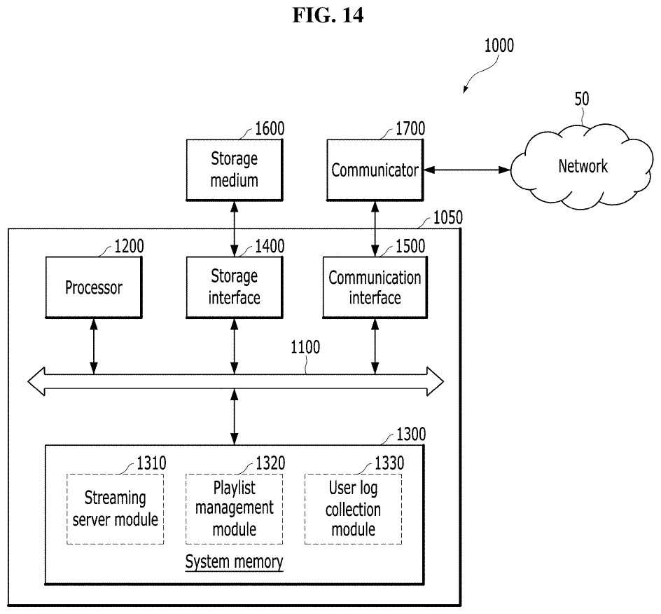

FIG. 14 is a block diagram illustrating an embodiment of a network server suitable for implementing the content providing server of FIG. 3.

Referring to FIG. 14, a network server 1000 includes a bus 1100, at least one processor 1200, a system memory 1300, a storage interface 1400, a communication interface 1500, a storage medium 1600, and a communicator 1700.

The bus 1100 is connected to various components of the network server 1000, and transmits data, signals and information. The processor 1200 may be any one of a general purpose processor and a special, programmed, or dedicated processor, and may control overall operations of the network server 1000.

The processor 1200 is configured to load, in the system memory 1300, program codes and instructions that provide various functions when being executed, and to execute or process the loaded program codes and instructions. The system memory 1300 may be provided as a working memory of the processor 1200. As an embodiment, the system memory 1300 may include at least one among a random access memory (RAM), a read only memory (ROM) and any other types of computer-readable media.

The processor 1200 may load, in the system memory 1300, a streaming server module 1310, a playlist management module 1320 and a user log collection module 1330 which perform or provide the operations or functions of the streaming server 311, the playlist manager 312 and the user log collector 313 of FIG. 3 when being executed by the processor 1200. The program codes and/or instructions may be executed by the processor 1200, and thereby, may perform the operations of the streaming server 311, the playlist manager 312 and the user log collector 313 described above with reference to FIG. 3.

The program codes and/or instructions may be loaded in the system memory 1300 from the storage medium 1600 being a separate computer-readable recording medium. Alternatively, the program codes and/or instructions may be loaded in the system memory 1300 through the communicator 1700 from the outside of the network server 1000.

In FIG. 14, the system memory 1300 is illustrated as a component separated from the processor 1200, but, alternatively, at least a part of the system memory 1300 may be included in the processor 1200.

The storage interface 1400 is connected to the storage medium 1600. The storage interface 1400 may interface between components, such as the processor 1200 and the system memory 1300 connected to the bus 1100, and the storage medium 1600. The communication interface 1500 is connected to the communicator 1700. The communication interface 1500 may interface between components, connected to the bus 1100, and the communicator 1700. The processor 1200 may communicate, through the communicator 1700, with the user terminal 110 (see FIG. 1) which is connected to the network 50.

In certain embodiments, the bus 1100, the processor 1200 and the system memory 1300 may be integrated into one board 1050. For example, the bus 1100, the processor 1200 and the system memory 1300 may be mounted on one semiconductor chip. In some embodiments, the one board 1050 may further include the storage interface 1400 and the communication interface 1500.

Examples of the storage medium 1600 may include various types of nonvolatile storage media, for example, a flash memory and a hard disk, which retain data stored therein even when power is cut off. At least a part of the storage medium 1600 may serve as the first and second databases DB1 and DB2 of FIG. 3.

The communicator 1700 (or a transceiver) may transmit and receive signals between the network server 1000 and other devices and/or servers in the network system 100 (see FIG. 1), through the network 50.

Although particular embodiments and application examples are described, they are provided only for assisting in the entire understanding of the disclosure. Therefore, the disclosure is not limited to the exemplary embodiments, and various modifications and changes may be made by those skilled in the art to which the disclosure pertains, from this description.

Therefore, the spirit of the disclosure should not be limited to the above-described exemplary embodiments, and the following claims as well as all modified equally or equivalently to the claims are intended to fall within the scopes and spirit of the disclosure.

What is claimed is:

1. A network server comprising:
a communicator connected to a network; and
at least one processor configured to communicate, through the communicator, with a user terminal connected to the network,
wherein the at least one processor is configured to:
include or associate content IDs, determined according to one or more requests received from the user terminal, in or with a playlist, each of the content IDs corresponding to a respective content file stored in a database,
reflect one or more actions of the user terminal, associated with one or more of content files, on log data sets corresponding to the content IDs, and
determine one or more of the content IDs as target IDs to be selectively deleted or excluded from the playlist, based on the log data sets.

2. The network server according to claim 1, wherein the at least one processor is configured to:
transmit information, associated with the target IDs, to the user terminal,
receive a signal selecting one or more of the target IDs from the user terminal, and
delete or exclude, in response to the signal selecting the one or more of the target IDs, the selected one or more of the target IDs from the playlist.

3. The network server according to claim 1, wherein each of the log data sets includes log data associated with a playback of one of the content files performed in the user terminal during a predetermined time from a time point at which a content ID corresponding to the one of the content files is included in or associated with the playlist.

4. The network server according to claim 3, wherein the log data includes information associated with an operation of skipping at least a part of a progress time of the one of the content files in the user terminal.

5. The network server according to claim 3, wherein the log data includes data indicating times, each of which at least a part of the one of the content files is played.

6. The network server according to claim 3, wherein the log data includes data counting the number of times that at least a part of the one of the content files is played in the user terminal.

7. The network server according to claim 3, wherein the at least one processor is configured to calculate scores corresponding to the content IDs, respectively, based on the log data sets, and select the target IDs according to the calculated scores.

8. The network server according to claim 1, wherein the content files include music files to be played by the user terminal through streaming.

9. A method for managing a playlist provided to a user terminal through a network, the method comprising:
including or associating content IDs, determined according to one or more requests received from the user terminal, in or with the playlist, each of the content IDs corresponding to a respective content file stored in a database;
reflecting one or more actions of the user terminal, associated with one or more of content files, on log data sets corresponding to the content IDs;
determining one or more of the content IDs as target IDs, based on the log data sets; and
selectively deleting or excluding the target IDs from the playlist.

10. The method according to claim 9, wherein the selectively deleting or excluding of the target IDs comprises:
transmitting information, associated with the target IDs, to the user terminal;
receiving a signal selecting one or more of the target IDs from the user terminal; and
deleting or excluding, in response to the signal selecting the one or more of the target IDs, the selected one or more of the target IDs from the playlist.

11. The method according to claim 9, wherein each of the log data sets includes log data associated with a playback of one of the content files performed in the user terminal during a predetermined time from a time point at which a content ID corresponding to the one of the content files is included in or associated with the playlist.

12. The method according to claim 11, wherein the determining of the one or more of the content IDs as the target IDs comprises:
calculating scores corresponding to the content IDs, respectively, based on the log data sets; and
determining the target IDs according to the calculated scores.

13. The method according to claim 12, wherein the calculating of the scores comprises:
determining whether the log data includes information associated with an operation of skipping at least a part of a progress time of the one of the content files in the user terminal; and
calculating a score of a corresponding content ID according to a determination result whether the log data includes the information associated with the operation of skipping the at least a part of the process time of the one of the content files in the user terminal.

14. The method according to claim 12, wherein the calculating of the scores comprises:
determining, from the log data, whether the number of times that at least a part of the one of the content files is played in the user terminal decreases with lapse of time; and
determining a score of a corresponding content ID according to a determination result whether the number of times that the at least a part of the one of the content files is played in the user terminal decreases with the lapse of time.

15. The method according to claim 12, wherein the calculating of the scores comprises:
determining, from the log data, whether the number of times that at least a part of the one of the content files is played in the user terminal is equal to or less than a threshold; and
determining a score of a corresponding content ID according to a determination result whether the number of times that the at least a part of the one of the content files is played in the user terminal is equal to or less than the threshold.

16. The method according to claim 9, wherein the content files include music files to be played by the user terminal through streaming.
